(19) United States
(12) Patent Application Publication
(10) Pub. No.: US 2025/0126377 A1
(43) Pub. Date: Apr. 17, 2025

(54) IMAGING DEVICE

(71) Applicant: SONY SEMICONDUCTOR SOLUTIONS CORPORATION, KANAGAWA (JP)

(72) Inventors: RYOHEI KAWASAKI, KANAGAWA (JP); KEIGO NAKAZAWA, KANAGAWA (JP)

(21) Appl. No.: 18/694,589

(22) PCT Filed: Aug. 22, 2022
(86) PCT No.: PCT/JP2022/031582

§ 371 Date: Mar. 22, 2024

(30) Foreign Application Priority Data
Oct. 6, 2021 (JP) 2021-164847

(51) Int. Cl. H04N 25/75; H04N 25/766

(52) U.S. Cl. CPC H04N 25/75; H04N 25/766

(57) ABSTRACT

[Object] Provided is an imaging device advantageous for high image quality and miniaturization. [Solving Means] An imaging device according to the present embodiment includes a plurality of pixels configured to perform photoelectrical conversion, a plurality of comparators each including a first input section configured to receive a pixel signal from a corresponding one of the pixels and a second input section configured to receive a reference signal to be compared with the pixel signal, the comparators being provided in correspondence with the plurality of respective pixels, a reference signal line configured to transmit the reference signal, and a setting circuit provided between the reference signal line and the second input section and configured to set a rate of change of a voltage level of the reference signal over time.

### TECHNICAL FIELD

The present disclosure relates to an imaging device.

### BACKGROUND ART

A pixel parallel AD (Analogue-to-Digital) CMOS (Complementary Metal Oxide Semiconductor) image sensor (hereinafter also simply referred to as a “CIS”) compares an analog pixel signal with a linearly changing reference signal (RAMP) by use of the comparator in each pixel. After that, the CIS counts the time that the reference signal takes to cross the pixel signal, thereby performing AD conversion of the pixel signal. This reference signal used to detect the pixel signal is directly input to the comparator within each pixel, which allows the CIS to perform AD conversion with the same gain for all the pixels.

Further, by arranging a plurality of reference signal lines for each pixel, a plurality of reference signals with different gains can be supplied to the respective different pixels. However, since the reference signal wiring includes a mesh wiring layer, it is necessary to provide a plurality of wiring layers in order to provide a plurality of wiring signal wiring lines. In this case, this hinders the miniaturization of the device.

### CITATION LIST

### Patent Literature

### [NPL 1]

M. Sakakibara, et al., “A Back-Illuminated Global-Shutter CMOS Image Sensor with Pixel-Parallel 14b Subthreshold ADC,” ISSCC Dig. Tech. Papers, pp. 80-82, February 2018.

### SUMMARY

### Technical Problem

An imaging device advantageous for high image quality and miniaturization is provided.

### Solution to Problem

An imaging device according to an aspect of the present disclosure includes a plurality of pixels configured to perform photoelectrical conversion, a plurality of comparators each including a first input section configured to receive a pixel signal from a corresponding one of the pixels and a second input section configured to receive a reference signal to be compared with the pixel signal, the comparators being provided in correspondence with the plurality of respective pixels, a reference signal line configured to transmit the reference signal, and a setting circuit provided between the reference signal line and the second input section and configured to set a rate of change of a voltage level of the reference signal over time.

The setting circuit includes a first capacitive element provided between the reference signal line and the second input section, a second capacitive element provided between the second input section and a ground voltage source, a first transistor of a first conductivity type provided between the second capacitive element and the ground voltage source, and a second transistor of a second conductivity type provided between a node between the second capacitive element and the first transistor, and the reference signal line, the second transistor having a gate connected to a gate of the first transistor in common.

In a first state where the first transistor is in a conducting state and the second transistor is in a non-conducting state, the first capacitive element and the second capacitive element change the voltage level of the reference signal at a first rate of change, and, in a second state where the first transistor is in a non-conducting state and the second transistor is in a conducting state, the first capacitive element and the second capacitive element change the reference signal at a second rate of change.

The setting circuit further includes a third transistor connected in parallel to the first capacitive element, in which, when all the pixels to be detected are in the second state, the setting circuit temporarily sets the third transistor to a conducting state to equalize a voltage level between the reference signal line and the second input section, and, after a transition of the voltage level of the reference signal to a change start level, each of the pixels enters either the first state or the second state.

The setting circuit further includes a third transistor connected in parallel to the first capacitive element. When all the pixels to be detected are in the second state, the setting circuit temporarily sets the third transistor to a conducting state to equalize a voltage level between the reference signal line and the second input section, and, before a transition of the voltage level of the reference signal in the first state or the second state to a change start level, each of the pixels enters either the first state or the second state.

The setting circuit changes the reference signal at the first rate of change in a first pixel of the plurality of pixels and changes the reference signal at the second rate of change in a second pixel of the plurality of pixels.

A capacitance ratio of the first capacitive element and the second capacitive element is different between the pixels.

The setting circuit changes the reference signal at the first rate of change in a first pixel of the plurality of pixels, changes the reference signal at the second rate of change in a second pixel of the plurality of pixels, and changes the reference signal at a third rate of change, which is different from the first rate of change and the second rate of change, in a third pixel of the plurality of pixels.

The comparators each execute determination processing of comparing the reference signal with the pixel signal to determine whether a voltage level of the pixel signal is higher or lower than a first threshold, and the setting circuit sets the rate of change of the reference signal for each of the pixels on the basis of a determination result of the determination processing.

In the determination processing, the rate of change of the reference signal is greater than the rate of change of the reference signal in detection processing of the pixel signal.

The imaging device further includes a determination circuit configured to determine whether a voltage level of the pixel signal is higher or lower than a second threshold. The setting circuit sets the rate of change of the reference signal for each of the pixels on the basis of a determination result of the determination circuit.

The imaging device further includes a determination result memory configured to retain the determination result.

The setting circuit is formed on the same substrate as the plurality of pixels.

The imaging device includes a first substrate having provided thereon the plurality of pixels, and a second substrate having provided thereon the setting circuit and stacked on the first substrate.

An imaging device according to another aspect of the present disclosure includes a plurality of pixels configured to perform photoelectric conversion, a comparator including a first input section configured to receive a pixel signal from a corresponding one of the pixels and a second input section configured to receive a reference signal to be compared with the pixel signal, a reference signal line configured to transmit the reference signal to the second input section, and a setting circuit provided between the reference signal line and the second input section and configured to set a rate of change of a voltage level of the reference signal over time. The comparator and the setting circuit are shared by the plurality of pixels.

### BRIEF DESCRIPTION OF DRAWINGS

FIG. 1 is a diagram depicting a schematic configuration of an imaging device according to the present disclosure.

FIG. 2 is a block diagram depicting a configuration example of a pixel and peripheral circuits near the pixel.

FIG. 3 is a conceptual diagram of an imaging device configured by stacking two semiconductor substrates, namely, an upper substrate and a lower substrate.

FIG. 4 is a circuit diagram depicting internal configurations of a pixel circuit, a comparator, a voltage conversion circuit, and a positive feedback circuit.

FIG. 5 is a circuit diagram depicting configurations of a slope setting circuit, a pixel, a pixel circuit, and a comparator according to a first embodiment.

FIG. 6A is an equivalent circuit diagram depicting an example of a connection state of the slope setting circuit.

FIG. 6B is an equivalent circuit diagram depicting an example of the connection state of the slope setting circuit.

FIG. 6C is an equivalent circuit diagram depicting an example of the connection state of the slope setting circuit.

FIG. 7 is a timing chart depicting an example of an operation of an imaging device according to the first embodiment.

FIG. 8 is a timing chart depicting an example of an operation of an imaging device according to Modified Example 1 of the first embodiment.

FIG. 9 is a plan view depicting an arrangement example of pixels in a pixel region according to a second embodiment.

FIG. 10 is a plan view depicting an arrangement example of pixels in a pixel region according to a third embodiment.

FIG. 11 is a circuit diagram depicting a configuration example of an imaging device according to a fourth embodiment.

FIG. 12 is a timing chart depicting an example of the operation of the imaging device according to the fourth embodiment.

FIG. 13 is a circuit diagram depicting a configuration example of an imaging device according to Modified Example 2 of the fourth embodiment.

FIG. 14 is a timing chart depicting an example of the operation of an imaging device 1 according to Modified Example 2.

FIG. 15 is a circuit diagram depicting a configuration example of an imaging device according to a fifth embodiment.

FIG. 16 is a diagram depicting a configuration example of an imaging device in which a plurality of pixel circuits shares peripheral circuits such as a comparator and a slope setting circuit.

FIG. 17 is a conceptual diagram of an imaging device configured by stacking three semiconductor substrates, namely, an upper substrate, an intermediate substrate, and a lower substrate.

FIG. 18 is a diagram depicting circuit arrangement examples of respective semiconductor substrates in a case where an imaging device is formed with three semiconductor substrates.

FIG. 19 is a block diagram depicting an example of schematic configuration of a vehicle control system.

FIG. 20 is a diagram of assistance in explaining an example of installation positions of an outside-vehicle information detecting section and an imaging section.

### DESCRIPTION OF EMBODIMENTS

Now, specific embodiments to which the present technology is applied are described in detail with reference to the drawings. The drawings are schematic or conceptual, and the proportions of each part or the like are not necessarily identical to real-world ones. In the specification and drawings, elements similar to those described earlier with respect to the foregoing drawings are denoted by the same reference signs, and the detailed description thereof is appropriately omitted.

### First Embodiment

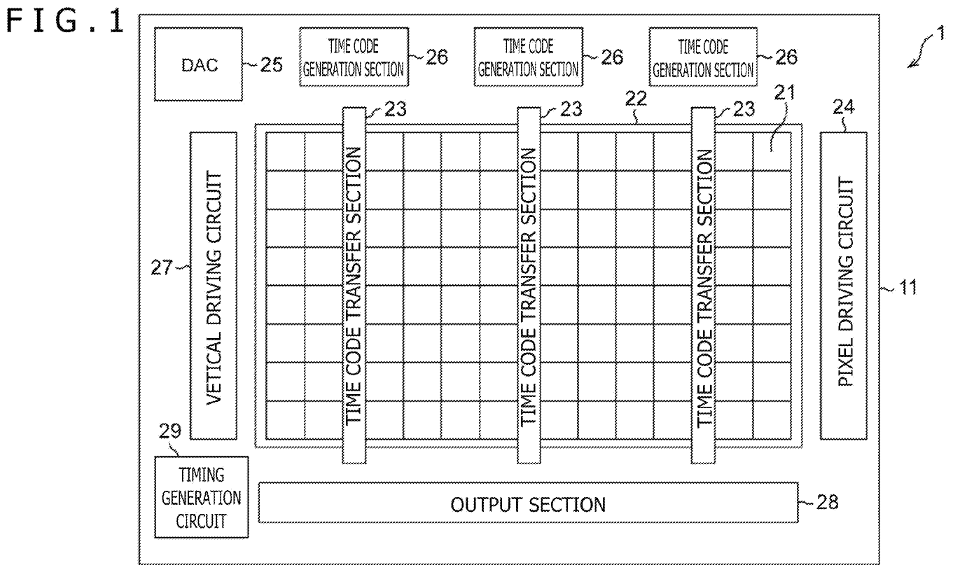

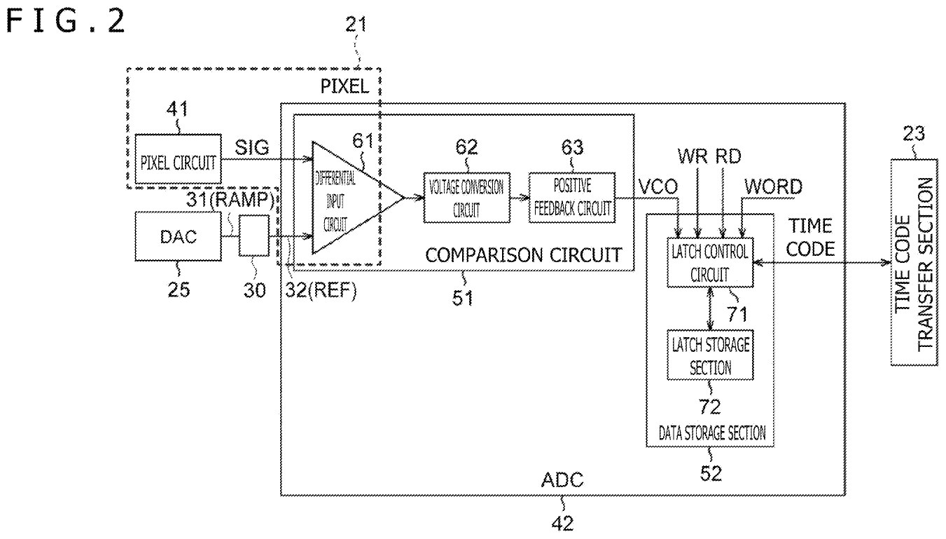

FIG. 1 depicts the schematic configuration of an imaging device according to the present disclosure. An imaging device 1 of FIG. 1 has, on a semiconductor substrate 11 using, for example, silicon (Si) as a semiconductor, a pixel region 22 in which pixels 21 are arranged in a two-dimensional array. The pixel region 22 is also provided with time code transfer sections 23 configured to transfer time codes generated by time code generation sections 26 to the respective pixels 21. Around the pixel region 22 on the semiconductor substrate 11, a pixel driving circuit 24, a DAC (Digital-to-Analogue Converter) 25, the time code generation sections 26, a vertical driving circuit 27, an output section 28, and a timing generation circuit 29 are provided. Note that, although not depicted, the pixel driving circuit 24, the DAC 25, the time code generation sections 26, the vertical driving circuit 27, the output section 28, the timing generation circuit 29, and a slope setting circuit 30 of FIG. 2 may be provided on a separate semiconductor substrate from the semiconductor substrate 11.

Each of the pixels 21 arranged in a two-dimensional array includes a pixel circuit 41 and an ADC (Analogue-to-Digital Converter) 42, as described later with reference to FIG. 2. The pixel 21 generates a charge signal (analog pixel signal SIG) based on the amount of light received by the light-receiving element (for example, photodiode) in the pixel, converts the charge signal to a digital pixel signal, and outputs the digital pixel signal.

The pixel driving circuit 24 drives the pixel circuit 41 (FIG. 2) in the pixel 21. The DAC 25 generates a reference signal RAMP, which is a slope signal whose level (voltage) monotonically decreases over time, and outputs the reference signal RAMP.

The time code generation section 26 generates time codes used when each of the pixels 21 converts the analog pixel signal SIG to a digital pixel signal (AD conversion) and supplies the time codes to a corresponding one of the time code transfer sections 23.

The plurality of time code generation sections 26 is provided for the pixel region 22, and the same number of the time code transfer sections 23 as the time code generation sections 26 is provided within the pixel region 22. That is, the time code generation sections 26 and the time code transfer sections 23 configured to transfer the time codes generated by the time code generation sections 26 have a one-to-one correspondence.

The vertical driving circuit 27 controls the output section 28 to output digital pixel signals in a predetermined order on the basis of the timing signals supplied from the timing generation circuit 29. The digital pixel signals are output from the output section 28 to the outside of the imaging device 1. The output section 28 performs predetermined digital signal processing, such as black level correction processing for black level correction and CDS (Correlated Double Sampling) processing, as needed, and then outputs the resultant to the outside.

The timing generation circuit 29 includes, for example, a timing generator configured to generate various timing signals and supplies the generated various timing signals to the pixel driving circuit 24, the DAC 25, the vertical driving circuit 27, and the like.

FIG. 2 is a block diagram depicting a configuration example of the pixel 21 and peripheral circuits near the pixel 21. The pixel 21 includes the pixel circuit 41 and a portion (for example, the differential pair) of a differential input circuit (hereinafter also referred to as a “comparator”) 61.

The pixel circuit 41 outputs a charge signal based on the amount of received light to the ADC 42 as the analog pixel signal SIG. The ADC 42 converts the analog pixel signal SIG supplied from the pixel circuit 41, to a digital signal.

The ADC 42 includes a comparison circuit 51 and a data storage section 52.

The comparison circuit 51 includes the comparator 61, a voltage conversion circuit 62, and a positive feedback (PFB) circuit 63. The comparison circuit 51 compares the reference signal REF with the analog pixel signal SIG and outputs the comparison result as an output signal VCO. The reference signal REF is supplied from the voltage conversion DAC 25 and adjusted in slope by the setting circuit 30. The comparison circuit 51 inverts the logic of the output signal VCO when the reference signal REF and the pixel signal SIG reach the same voltage level.

The DAC 25 generates and outputs the reference signal RAMP that serves as a comparison criterion for the analog pixel signal SIG.

The slope setting circuit 30 receives the reference signal RAMP from the DAC 25 and sets the rate of change (slope) of the voltage level of the reference signal RAMP over time. The reference signal RAMP with the slope set by the slope setting circuit 30 is conveniently referred to as a “reference signal REF.” That is, the slope setting circuit 30 adjusts the slope of the reference signal RAMP and outputs the resultant to the comparator 61 as the reference signal REF.

The slope setting circuit 30 is connected to the DAC 25 through a reference signal line 31 and connected to the input section of the comparator 61 through a reference signal line 32.

The data storage section 52 receives the output signal VCO from the comparison circuit 51. Further, the data storage section 52 receives a WR signal indicating a write operation of pixel signals, an RD signal indicating a read operation of pixel signals, and a WORD signal for controlling a read timing of the pixel 21 during the read operation of the pixel signals, from the vertical driving circuit 27. Moreover, the data storage section 52 also receives the time codes generated by the time code generation section 26 through the time code transfer section 23.

The data storage section 52 includes a latch control circuit 71 configured to control the write and read operations of time codes on the basis of WR signals and RD signals, and a latch storage section 72 configured to store time codes.

During a write operation of time codes, the latch control circuit 71 causes the latch storage section 72 to store the time codes supplied from the time code transfer section 23 and updated every unit time, while receiving the output signal VCO at a high level from the comparison circuit 51.

When the reference signal REF and the pixel signal SIG reach the same voltage level and the output signal VCO supplied from the comparison circuit 51 is inverted to a low level, the latch control circuit 71 stops the write (update) of time codes to allow the latch storage section 72 to retain the time code last stored in the latch storage section 72. The time codes stored in the latch storage section 72 represent the times when the pixel signal SIG and the reference signal REF reach the same voltage level, that is, indicate digital pixel signals.

After the sweep of the reference signal REF is completed and the time codes of all the pixels 21 in the pixel region 22 are stored in the latch storage section 72, the latch control circuit 71 is changed from the write operation to the read operation.

During the read operation of time codes, the latch control circuit 71 outputs, on the basis of WORD signals for controlling read timing, the time codes (digital pixel signals) stored in the latch storage section 72 to the time code transfer section 23. The time code transfer section 23 sequentially transfers the time codes in the column direction (vertical direction) to supply the time codes to the output section 28 of FIG. 1.

The time code when the output signal VCO is inverted is a digital pixel signal after AD conversion, and hence is hereinafter also referred to as a “digital pixel signal.”

The imaging device 1 is configured as described above. Note that all the circuits forming the imaging device 1 may be provided on the single semiconductor substrate 11 as described above, or the circuits forming the imaging device 1 may be arranged on a plurality of semiconductor substrates in a divided manner.

Now, the imaging device 1 is further described as being configured by stacking a plurality of semiconductor substrates.

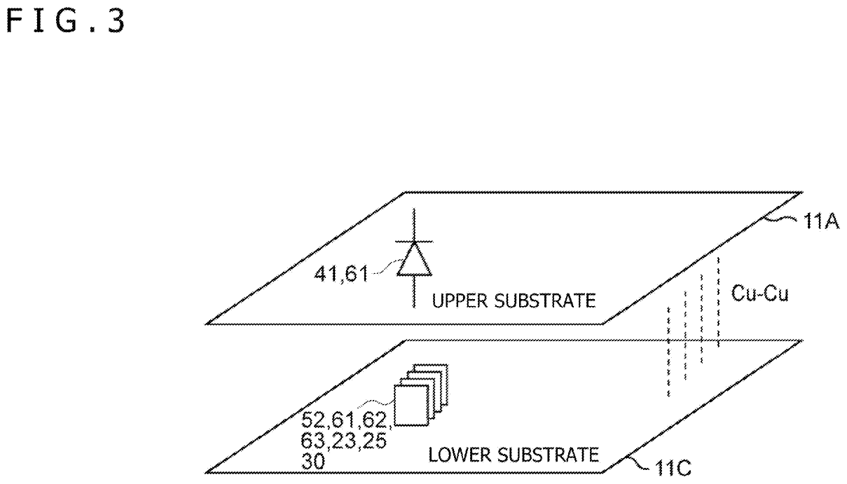

FIG. 3 is a conceptual diagram of the imaging device 1 configured by stacking two semiconductor substrates, namely, an upper substrate 11A and a lower substrate 11C.

The upper substrate 11A is provided with at least the pixel circuit 41 and a portion (for example, the differential pair) of the comparator 61. That is, the upper substrate 11A is provided with the pixel 21. The lower substrate 11C is provided with the data storage section 52, another portion (for example, the current mirror circuit) of the comparator 61, the voltage conversion circuit 62, the positive feedback circuit 63, the time code transfer section 23, the DAC 25, the slope setting circuit 30, and the like. The upper substrate 11A is bonded to the lower substrate 11C by metal bonding such as Cu—Cu.

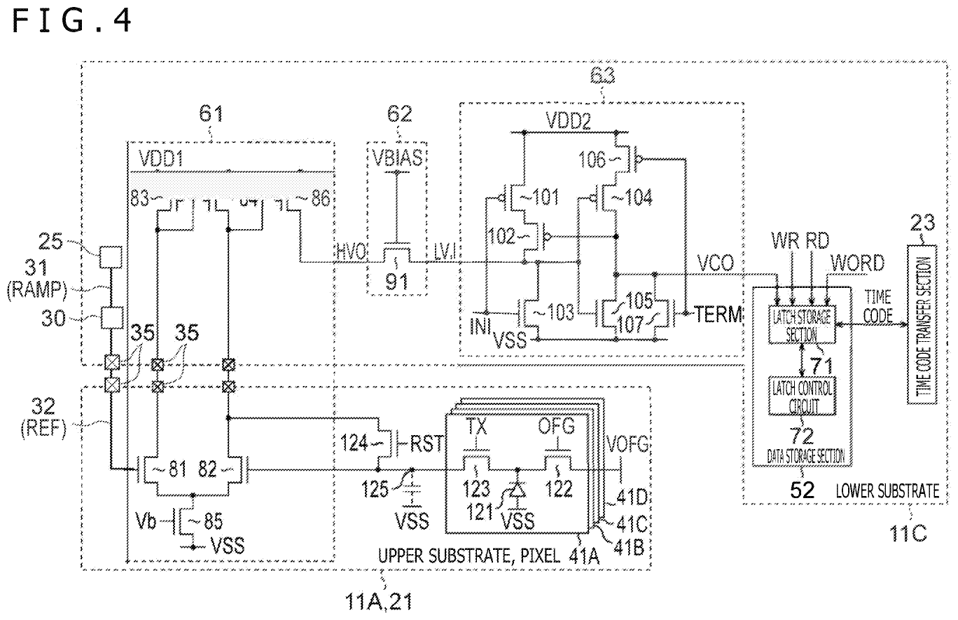

FIG. 4 is a circuit diagram depicting the internal configurations of the pixel circuit 41A, the comparator 61, the voltage conversion circuit 62, and the positive feedback circuit 63. Note that the upper substrate 11A is electrically connected to the lower substrate 11C through Cu—Cu bonding sections 35.

The pixel circuit 41 includes a photodiode (PD) 121 serving as a photoelectric conversion element, a discharge transistor 122, a transfer transistor 123, a reset transistor 124, and a FD (floating diffusion layer) 125.

The discharge transistor 122 is used in a case where the exposure period is adjusted. Specifically, when it is desired to start an exposure period at any timing, the discharge transistor 122 is turned on to discharge the charges accumulated in the photodiode 121 before this. Thus, from after the discharge transistor 122 is turned off, the exposure period starts.

The transfer transistor 123 transfers the charges generated by the photodiode 121 to the FD 125. The reset transistor 124 resets the charges retained in the FD 125. The FD 125 is connected to a gate (first input section) of a transistor 82 of the comparator 61. With this, the transistor 82 of the comparator 61 also functions as an amplification transistor for the pixel circuit 41.

A source of the reset transistor 124 is connected to the gate of the transistor 82 of the comparator 61 and the FD 125. A drain of the reset transistor 124 is connected to a drain of the transistor 82. Thus, there is no fixed reset voltage for resetting the charges in the FD 125. This is to make the following possible by controlling the circuit state of the comparator 61: setting the reset voltage for resetting the FD 125 to any value using the reference signal REF, and storing a fixed pattern noise of the circuit in the FD 125 and canceling the components of the fixed pattern noise through CDS operation.

The comparator 61 compares the analog pixel signal SIG output from the pixel circuit 41 in the pixel 21 with the reference signal REF output from the DAC 25 and outputs a predetermined signal when the pixel signal SIG is higher than the reference signal REF. The comparators 61 are provided in correspondence with the plurality of respective pixels 21.

The comparator 61 includes transistors 81 and 82 serving as a differential pair, transistors 83 and 84 forming a current mirror, a transistor 85 serving as a constant current source configured to supply a current Icm based on an input bias current Vb, and a transistor 86 configured to output an output signal HVO of the comparator 61. Regarding the comparator 61 of the present embodiment, the transistors 81, 82, and 85 of the comparator 61 are provided on the upper substrate 11A, and the transistors 83, 84, and 86 thereof are provided on the lower substrate 11C.

The transistors 81, 82, and 85 include N-type MOS (Metal Oxide Semiconductor) transistors, while the transistors 83, 84, and 86 include P-type MOS transistors.

Among the transistors 81 and 82 serving as a differential pair, a gate (second input section) of the transistor 81 receives the reference signal REF output from the slope setting circuit 30. The gate (first input section) of the transistor 82 receives the analog pixel signal SIG output from the pixel circuit 41. Sources of the transistors 81 and 82 are connected to a drain of the transistor 85, and a source of the transistor 85 is connected to a predetermined source voltage VSS (VSS<VDD2<VDD1).

A drain of the transistor 81 is connected to gates of the transistors 83 and 84, which form a current mirror circuit, and to a drain of the transistor 83. The drain of the transistor 82 is connected to a drain of the transistor 84 and a gate of the transistor 86. Sources of the transistors 83, 84, and 86 are connected to a power supply voltage VDD1.

The transistors 83 and 84 function as a current mirror circuit and pass equal currents to the respective transistors 81 and 82. On the other hand, the differential pair of the transistors 81 and 82 enter a conducting state depending on a magnitude relation of the voltage level between the reference signal REF and the pixel signal SIG. For example, in a case where the voltage level of the reference signal REF is higher than that of the pixel signal SIG, the transistor 81 is closer to a conducting state (ON state) than the transistor 82. In this case, the voltage of the transistors 83 and 84 drops, and the transistors 83 and 84 pass more current. With this, the gate voltage of the transistor 86 rises, and the transistor 86 enters a non-conducting state (OFF state). In this case, the output signal HVO of the comparator 61 has a low-level voltage. In contrast to this, for example, in a case where the voltage level of the reference signal REF is lower than that of the pixel signal SIG, the transistor 81 is closer to a non-conducting state (OFF state) than the transistor 82. In this case, the voltage of the transistors 83 and 84 rises, and the transistors 83 and 84 pass no current. With this, the gate voltage of the transistor 86 drops, and the transistor 86 enters a conducting state (ON state). In this case, the output signal HVO of the comparator 61 has a high-level voltage. In this manner, the comparator 61 compares the voltage levels of the reference signal REF and the pixel signal SIG with each other and outputs the output signal HVO based on the magnitude relation between the voltage level of the reference signal REF and that of the pixel signal SIG. The comparator 61 inverts the output signal HVO when the voltage level of the reference signal REF crosses the voltage level of the pixel signal SIG.

The voltage conversion circuit 62 includes, for example, an N-type MOS transistor 91. A drain of the transistor 91 is connected to a drain of the transistor 86 of the comparator 61, and a source of the transistor 91 is connected to a predetermined connection point in the positive feedback circuit 63, while the gate of the transistor 86 is connected to a bias voltage VBIAS.

The transistors 81 to 86 forming the comparator 61 are circuits configured to operate in the voltage range from the voltage VSS to the power supply voltage VDD1, and the positive feedback circuit 63 is a circuit configured to operate at a power supply voltage VDD2 lower than the power supply voltage VDD1. The voltage conversion circuit 62 converts the output signal HVO input from the comparator 61, to a low-voltage signal (converted signal) LVI, with which the positive feedback circuit 63 can operate, and supplies the low-voltage signal to the positive feedback circuit 63.

The bias voltage VBIAS may be any voltage that achieves conversion to a voltage that does not damage each of transistors 101 to 105 of the positive feedback circuit 63 configured to operate at a constant voltage. For example, the bias voltage VBIAS can be the same voltage as the power supply voltage VDD2 of the positive feedback circuit 63 (VBIAS=VDD2).

The positive feedback circuit 63 outputs an output signal (comparison result signal) VCO obtained by inverting the logics of the signals HVO and LVI on the basis of the converted signal LVI obtained by converting the output signal HVO from the comparator 61, to a signal corresponding to the power supply voltage VDD2. Further, the positive feedback circuit 63 has a function to increase a transition speed of the inversion of the output signal VCO.

The positive feedback circuit 63 includes transistors 101 to 107. The transistors 101, 102, 104, and 106 include, for example, P-type MOS transistors, while the transistors 103, 105, and 107 include, for example, N-type MOS transistors.

The source of the transistor 91, which serves as the output end of the voltage conversion circuit 62, is connected to drains of the transistors 102 and 103, and to gates of the transistors 104 and 105. A source of the transistor 101 is connected to the power supply voltage VDD2, and a drain of the transistor 101 is connected to a source of the transistor 102, while a gate of the transistor 102 is connected to drains of the transistors 104 and 105, which also serve as the output end of the positive feedback circuit 63.

Sources of the transistors 103, 105, and 107 are connected to the predetermined source voltage VSS. Gates of the transistors 101 and 103 are supplied with an initialization signal INI. A gate of the transistor 106 and a gate of the transistor 107 are supplied with a control signal TERM.

A source of the transistor 106 is connected to the power supply voltage VDD2, and a drain of the transistor 106 is connected to a source of the transistor 104. A drain of the transistor 107 is connected to the output end of the positive feedback circuit 63, and the source of the transistor 107 is connected to the predetermined source voltage VSS.

When the control signal TERM is set to a high level, the transistors 106 and 107 bring the output signal VCO to a low level independently of the state of the differential input circuit 61. For example, when the voltage level of the pixel signal SIG falls below the final voltage of the reference signal REF due to higher-than-expected high luminance (for example, sunlight entering the angle of view of the imaging device 1), the comparison period ends with the output signal VCO of the positive feedback circuit 63 remaining high, and the data storage section 52, which is controlled by the output signal VCO, fails to fix the value, resulting in the loss of the AD conversion function. To prevent the occurrence of such a situation, the control signal TERM is set to a high level in a pulse shape at the end of the sweep of the reference signal REF, thereby forcibly inverting the output signal VCO that has not yet been inverted to a low level. The data storage section 52 stores (latches) the time code just before the forced inversion, and hence, the ADC 42 ultimately serves as an AD converter with a clamped output value with respect to luminance input equal to or higher than a certain level.

When the bias voltage VBIAS is set to a low level to make the transistor 91 enter a non-conducting state, and the initialization signal INI is set to a high level, the output signal VCO becomes a high level independently of the state of the comparator 61. Thus, by combining the forced high-level output of the output signal VCO with the forced low-level output due to the control signal TERM described above, the output signal VCO can be set to any value independently of the states of the comparator 61, the pixel circuit 41, and the DAC 25. With this function, for example, it is possible to test the circuits on the latter stages of the comparator 61 only with electrical signal input, without relying on optical input to the imaging device 1.

Note that the upper substrate 11A can be a substrate only with N-type MOS transistors, and the lower substrate 11C can be a logic circuit substrate on which circuits upstream of the P-type MOS transistors included in the differential input circuit 61 are formed. With this configuration, with respect to the slow response of the P-type MOS transistors of the differential input circuit 61, a rapid response can be made when the threshold of the NOR circuit on the latter stage is exceeded, as feedback (Positive Feed Back) to the P-type MOS transistors on the constant voltage side.

Thus, the time of through current is minimized, thereby making it possible to accurately latch and store the digital signals (gray codes) simultaneously supplied from the outside. The latched data is output to an external processing section and used for processing such as CDS.

The DAC 25 and the slope setting circuit 30 are provided on the lower substrate 11C.

Next, the configuration of the slope setting circuit 30 is described.

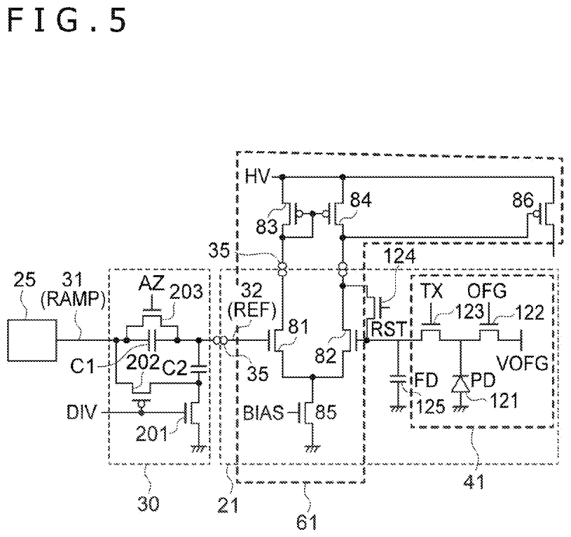

FIG. 5 is a circuit diagram depicting configurations of the slope setting circuit 30, the pixel 21, the pixel circuit 41, and the comparator 61 according to the first embodiment. The configurations of the pixel 21, the pixel circuit 41, and the comparator 61 are as described with reference to FIG. 4.

The slope setting circuit 30 includes capacitors C1 and C2, and transistors 201 to 203. One end of the capacitor C1, which serves as a first capacitive element, is connected to the reference signal line 31 and electrically connected to the DAC 25 through the reference signal line 31. The other end of the capacitor C1 is connected to the gate of the transistor 81 of the comparator 61 through the reference signal line 32 and the Cu—Cu bonding section 35. That is, the capacitor C1 is provided between the reference signal line 31 and the gate (second input section) of the transistor 81.

One end of the capacitor C2, which serves as a second capacitive element, is connected to the reference signal line 32 and connected to the gate of the transistor 81 and the other end of the capacitor C1 through the reference signal line 32. The other end of the capacitor C2 is connected to a drain of the transistor 201 and connected to the ground (ground voltage source) through the transistor 201. That is, the capacitor C2 is provided between the gate of the transistor 81 and the ground.

The transistor 201, which serves as a first transistor, is, for example, an N-type MOS transistor. The drain of the transistor 201 is connected to the other end of the capacitor C2, and the source thereof is connected to the ground. Thus, the transistor 201 is provided between the capacitor C2 and the ground. A gate of the transistor 201 receives a control signal DIV.

The transistor 202, which serves as a second transistor, is, for example, a P-type MOS transistor. A drain of the transistor 202 is connected to a node N1 between the reference signal line 31 and the capacitor C1, and the source thereof is connected to the reference signal line 31. Thus, the transistor 202 is provided between the node N1 and the reference signal line 31. A gate of the transistor 202 is connected to the gate of the transistor 201 in common and receives the control signal DIV.

The transistor 203, which serves as a third transistor, is, for example, an N-type MOS transistor. A drain of the transistor 203 is connected to one end of the capacitor C1, and the source thereof is connected to the other end of the capacitor C1. That is, the transistor 203 is connected in parallel to the capacitor C1. A gate of the transistor 203 receives a reset signal AZ.

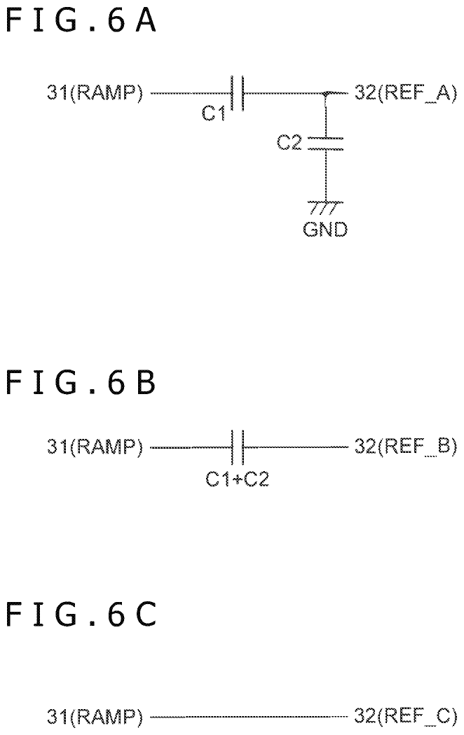

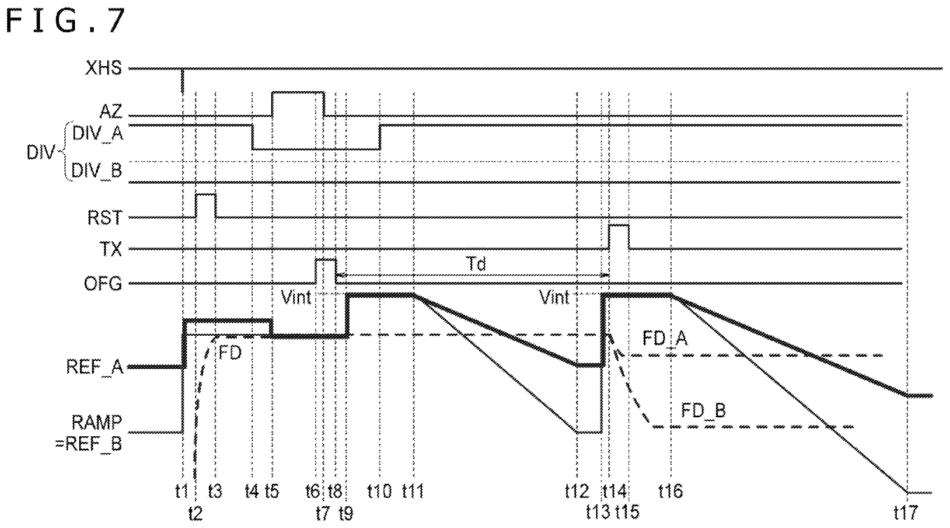

With such a configuration, the slope setting circuit 30 sets the slope (rate of change over time) of the voltage level of the reference signal RAMP obtained from the DAC 25 through the reference signal line 31. FIG. 6A to FIG. 6C are equivalent circuit diagrams depicting examples of the connection state of the slope setting circuit 30. For example, in a case where the control signal DIV is at a high level, the transistor 201 is in a conducting state, and the transistor 202 is in a non-conducting state. With this, the capacitors C1 and C2 are in a connected state (first state) depicted in FIG. 6A. That is, the capacitor C1 is connected between the reference signal line 31 and the reference signal line 32. The capacitor C2 is connected between the reference signal line 32 and the ground GND. With this, the slope setting circuit 30 divides the reference signal RAMP in capacitance and outputs the resultant as a reference signal REF_A. A change in the voltage level of the reference signal REF_A is smaller than a change in the voltage level of the reference signal RAMP due to capacitance division.

For example, in a case where the control signal DIV is at a low level, the transistor 201 is in a non-conducting state, and the transistor 202 is in a conducting state. With this, the capacitors C1 and C2 are in a parallelly connected state (second state) depicted in FIG. 6B. That is, the capacitors C1 and C2 are connected in parallel between the reference signal line 31 and the reference signal line 32. With this, the slope setting circuit 30 outputs the reference signal RAMP as a reference signal REF_B while maintaining the voltage level of the reference signal RAMP without dividing the reference signal RAMP in capacitance. While maintaining the voltage difference between the reference signal REF_B and the reference signal RAMP, the voltage level of the reference signal REF_B changes almost equivalently to a change in the voltage level of the reference signal RAMP.

When the reset signal AZ becomes a high level, the transistor 203 enters a conducting state, and the reference signal line 31 and the reference signal line 32 are short-circuited, resulting in a third state depicted in FIG. 6C. In this case, the slope setting circuit 30 outputs the reference signal RAMP as it is, as a reference signal REF_C. That is, the voltage level of the reference signal REF_C is equal to the voltage level of the reference signal RAMP.

In this manner, according to the present embodiment, the slope (first rate of change) of the voltage level of the reference signal REF_A in the first state depicted in FIG. 6A is smaller (gentler) than the slope (second rate of change) of the voltage level of the reference signal REF_B in the second state depicted in FIG. 6B. That is, the slope setting circuit 30 can switch and change the slope of the reference signal RAMP depending on the control signal DIV. The imaging device 1 according to the present embodiment can acquire pixel signals with different gains in one shot while maintaining the same exposure time and exposure timing, through the switching of the slope of the reference signal RAMP. As a result, the detectable voltage range of pixel signals can be expanded to allow the imaging device 1 to support HDR (High Dynamic Range). Further, by changing the slope of the reference signal RAMP depending on the voltage levels of pixel signals, the resolution can be expanded without significantly extending the imaging time. That is, the imaging device 1 can achieve both increased image quality and accelerated read speed.

The slope of the reference signal REF in the first state of FIG. 6A can be changed by changing the capacitance ratio of the capacitors C1 and C2. For example, in a case where the capacitors C1 and C2 have equal capacitance, the capacitance ratio (C1/(C1+C2)) of the capacitors C1 and C2 is ½. In this case, the gain of the imaging device 1 in the first state of FIG. 6A is half of that in the second state of FIG. 6B. For example, in a case where the capacitance of the capacitor C2 is three times greater than the capacitance of the capacitor C1, the capacitance ratio (C1/(C1+C2)) of the capacitors C1 and C2 is ¼. In this case, the gain of the imaging device 1 in the first state of FIG. 6A is one-fourth of that in the second state of FIG. 6B. When either the capacitor C1 or C2 is a variable capacitive element, the gain can be set for each pixel. This leads to HDR, high image quality, and accelerated read speed.

Next, the operation of the imaging device 1 according to the present embodiment is described.

FIG. 7 is a timing chart depicting an example of the operation of the imaging device 1 according to the first embodiment. The horizontal axis indicates time, and the vertical axis indicates the voltage levels of various control signals and reference signals. Note that the exposure processing of the pixel 21 is performed in a predetermined scan order for each pixel row or for a plurality of pixel rows of the pixel region 22. FIG. 7 is a timing chart depicting the operation of one scan (1H). A dashed line FD indicates the voltage level (analog pixel signal) of the FD 125 for each of the pixels 21.

The control signal DIV has control signals DIV A and DIV_B. The control signal DIV A is at a high level except for some periods. In a case where the control signal DIV A is at a high level, the state of the slope setting circuit 30 is in the first state depicted in FIG. 6A. In a case where the control signal DIV A is at a low level, the state of the slope setting circuit 30 is in the second state depicted in FIG. 6B. The control signal DIV_B is always at a low level. In this case, the state of the slope setting circuit 30 is maintained in the second state depicted in FIG. 6B.

The control signal DIV A or DIV_B that is received by the slope setting circuit 30 is set for each of the pixels 21. In a case where the control signal DIV A is input to the slope setting circuit 30, the reference signal REF_A is supplied to the pixel 21. In a case where the control signal DIV_B is input to the slope setting circuit 30, the reference signal REF_B is supplied to the pixel 21. Thus, the pixel region 22 includes the pixel 21 to be supplied with the reference signal REF_A and the pixel 21 to be supplied with the reference signal REF_B. In FIG. 7, the reference signals REF_A and REF_B are depicted in an overlapped manner.

First, at t1, a horizontal synchronization signal XHS is input, and the exposure processing of pixels PX in one or a plurality of pixel rows starts. The DAC 25 raises the reference signal RAMP to a predetermined voltage. At this time, in a case where the slope setting circuit 30 is in the first state of FIG. 6A, the reference signal supplied from the reference signal line 32 to the comparator 61 rises as REF_A of FIG. 7. In a case where the slope setting circuit 30 is in the second state of FIG. 6B, the reference signal supplied from the reference signal line 32 to the comparator 61 rises as REF_B of FIG. 7. Note that a change in the voltage of the reference signal REF_A is smaller than a change in the voltage of the reference signal RAMP due to resistance division. A change in the voltage of the reference signal REF_B is almost equal to a change in the voltage of the reference signal RAMP.

Next, at t2, the reset signal RST rises, and the reset transistor 124 is turned on. With this, the FD 125 (the gate of the transistor 82) and the drain of the transistor 82 are short-circuited to eliminate the charges retained in the FD 125, and the voltage of the FD 125 is reset to a high-level power supply voltage HV.

Next, at t3, the reset signal RST falls, and the reset transistor 124 is turned off. With this, the FD 125, which has been reset to the high-level power supply voltage HV, enters an electrically floating state.

Next, at t4, the control signal DIV A falls. With this, all the slope setting circuits 30 enter the second state once. However, even in the second state, since the reference signal line 32 is electrically disconnected from the reference signal line 31 by the capacitor C1 or C2, as long as the reference signal RAMP is maintained, the voltage levels of the reference signals REF_A and REF_B are maintained.

Next, at t5, the reset signal AZ rises. With this, all the slope setting circuits 30 enter the third state depicted in FIG. 6C. With this, the reference signal line 31 and the reference signal line 32 are short-circuited, and hence, the reference signal REF_A is reset to the same voltage level as the reference signal REF_B, that is, as the reference signal line RAMP.

Next, at t6, a control signal OFG rises to a high level, and hence, the transistor 122 is turned on once. With this, to set the start of an exposure period Td, the transistor 122 discharges the charges generated by the PD 121. Note that the pulse of the control signal OFG may be set at and before the point of time of the falling edge of the horizontal synchronization signal XHS (t1). In this case, the start of the exposure period Td occurs before the point of time of the falling edge of the horizontal synchronization signal XHS (t1), so that the exposure period Td can be extended.

Next, at t7, the reset signal AZ falls. With this, all the slope setting circuits 30 return to the second state.

Next, at t8, the control signal OFG falls, and the transistor 122 is turned off. With this, the PD 121 is able to accumulate charges, and the exposure period Td starts.

Next, at t9, the reference signal RAMP is set to an initial voltage Vint at the start of the slope operation. At this time, all the slope setting circuits 30 are still in the second state, and hence, the reference signals REF_A and REF_B change in almost the same manner as the reference signal RAMP.

Next, at t10, the control signal DIV A rises, and the slope setting circuit 30 receiving the control signal DIV A returns to the first state, while the slope setting circuit 30 receiving the control signal DIV_B is maintained in the second state. At this time, since the reference signal line 32 is separated from the reference signal line 31 by the capacitor C1 or C2 at any of the pixels 21, the charges on the reference signal line 32 are maintained. Thus, the voltage of the reference signals REF_A and REF_B is maintained at the voltage level of the reference signal RAMP.

Next, at t11, the slope operation of the reference signal RAMP starts. At this time, the DAC 25 changes (for example, reduces) the voltage of the reference signal RAMP with a predetermined slope. Here, since the slope setting circuit 30 receiving the control signal DIV A is in the first state, the slope setting circuit 30 in question outputs the reference signal REF_A with a gentler slope than the reference signal RAMP due to the capacitance division of the capacitors C1 and C2. On the other hand, since the slope setting circuit 30 receiving the control signal DIV_B is in the second state, the slope setting circuit 30 in question outputs the reference signal REF_B with a slope almost equal to that of the reference signal RAMP.

In the period from t11 to t12, the transistor 123 is in the off state, and the charges in the PD 121 are not transferred to the FD 125. Thus, in the period from t11 to t12, the reset level of the pixel 21 is detected.

When the reference signal REF_A or REF_B crosses the pixel signal level of the pixel 21, the comparator 61 inverts the logic of the output signal HVO. A counter, which is not depicted, counts the time from the start of the slope operation of the reference signal RAMP to the inversion of the output signal HVO on the basis of a clock signal. This counter value serves as a digital pixel signal at the reset level.

Next, at t13, the reference signal RAMP is set again to the initial voltage Vint.

Next, at t14, a control signal (transfer signal) TX rises, and the transistor 123 transfers the charges (for example, electrons) accumulated in the PD 121 to the FD 125. With this, the potential of the FD 125 varies depending on the intensity of light received by the PD 121. For example, in the case of low light intensity, as a pixel signal FD_A, the potential of the FD 125 does not drop significantly. On the other hand, in the case of high light intensity, as a pixel signal FD_B, the potential of the FD 125 drops significantly.

Next, at t15, the control signal TX falls, and the transistor 123 is turned off.

Next, at t16, the slope operation of the reference signal RAMP starts. With this, the pixel signals FD_A and FD_B at the signal level are detected. The pixel signal FD_A is detected by use of the reference signal REF_A, and the pixel signal FD_B is detected by use of the reference signal REF_B.

Here, the pixel signal FD_A, which has not dropped significantly from the reset level, can be detected even using the reference signal REF_A with a small slope (large gain). However, the pixel signal FD_B, which has dropped significantly from the reset level, cannot be detected within the predetermined detection period from t16 to t17 with the reference signal REF_A. Even when the pixel signal FD_B can be detected within the predetermined detection period from t16 to t17, the detection time is longer, resulting in a drop in the read speed of pixel signals. By using the reference signal REF_B with a large slope (small gain), the pixel signal FD_B can be detected. Alternatively, by using the reference signal REF_B, the detection time of the pixel signal FD_B can be shortened, thereby accelerating the read speed of pixel signals.

On the other hand, when the pixel signal FD_A is detected by use of the reference signal REF_B with a large slope (small gain), it leads to a drop in image quality. By detecting the pixel signal FD_A by use of the reference signal REF_A with a small slope (large gain), high image quality digital pixel signals can be generated.

At t17, the detection operation of pixel signals for one scan is completed. After that, the digital pixel signal at the reset level, and the digital pixel signal at the signal level are stored in the latch control circuit 71 of the data storage section 52. Moreover, the digital pixel signals at the reset level and the signal level are subjected to CDS (Correlated Double Sampling) processing in a signal processing circuit, which is not depicted, to become image data.

In this manner, according to the present disclosure, the slope setting circuits 30 can generate the plurality of reference signals REF_A and REF_B with different slopes (rates of change in voltage over time) from the single reference signal RMP and supply the different reference signals REF_A and REF_B to the respective pixels 21. With this, the imaging device 1 can detect pixel signals with the reference signals REF_A and REF_B based on light intensity. As a result, while high image quality is maintained, HDR and high-speed reading can be achieved.

Further, according to the present disclosure, the slope setting circuits 30 corresponding to the respective pixels 21 generate the reference signals REF_A and REF_B from the single reference signal RAMP. Thus, there is no need to prepare the plurality of reference signals RAMP, and a single wiring layer is sufficient for the wiring layer for transmitting the reference signal RAMP. Thus, the imaging device 1 according to the present embodiment is advantageous for miniaturization.

### Modified Example 1

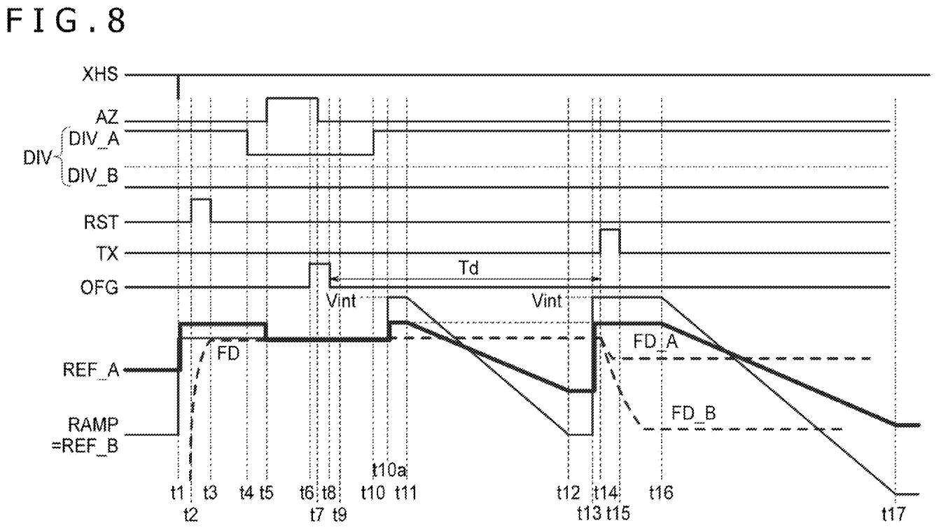

FIG. 8 is a timing chart depicting an example of the operation of the imaging device 1 according to Modified Example 1 of the first embodiment.

In the operation depicted in FIG. 7 referred to above, when all the pixels 21 to be detected are in the second state, the transistor 203 is temporarily turned on by the reset signal AZ, thereby equalizing the voltage level between the reference signal line 31 and the gate of the transistor 81 in each of the pixels 21 (t5 to t6). Then, after the transition of the voltage level of the reference signal RAMP to the initial voltage Vint at the start of the slope operation, each of the pixels 21 enters either the first state or the second state. Thus, in the first embodiment, at t11 at which the slope operation starts, when the reference signal RAMP is set to the initial voltage Vint, the reference signals REF_A and REF_B are also set to be almost equal to the reference signal RAMP.

In contrast to this, Modified Example 1 is the same as the first embodiment in that, when all the pixels 21 to be detected are in the second state, the transistor 203 is temporarily turned on (t5 to t6). However, in Modified Example 1, after each of the pixels 21 has entered either the first state or the second state at t10, at t10a, the voltage level of the reference signal RAMP transitions to the initial voltage Vint. That is, before the transition of the voltage level of the reference signal RAMP to the initial voltage Vint, each of the pixels 21 enters either the first state or the second state.

Thus, in Modified Example 1, at t11 at which the slope operation starts, when the reference signal RAMP is set to the initial voltage Vint, the reference signal REF_B in the second state is set to be almost equal to the reference signal RAMP. However, the reference signal REF_A in the first state changes by the width corresponding to a voltage change range of the reference signal RAMP divided in capacitance. Thus, at t11 at which the slope operation starts, the reference signals REF_A and REF_B are set to voltage levels different from each other.

The reference signals REF_A and REF_B are at different voltage levels at the start of the slope operation. However, since the charge state of the reference signal line 32 is the same during the detection of the reset level and signal level, the voltage difference between the reference signals REF_A and REF_B is offset through CDS processing. Thus, Modified Example 1 can detect pixel signals like the first embodiment.

The configuration and other operations of Modified Example 1 may be similar to those of the first embodiment. Thus, Modified Example 1 can obtain similar effects to the first embodiment.

### Second Embodiment

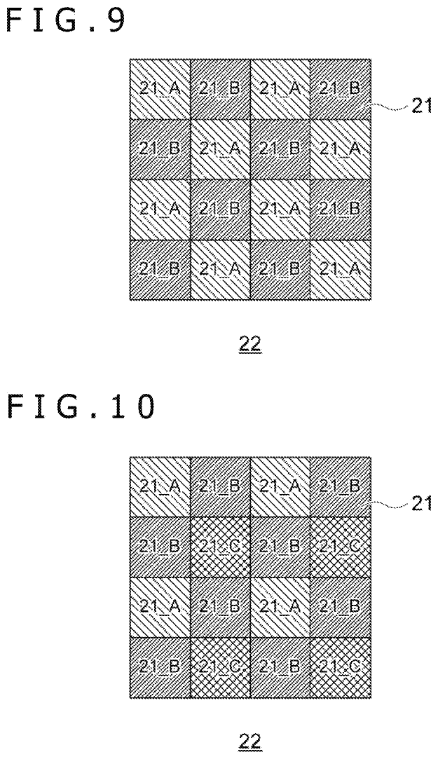

FIG. 9 is a plan view depicting an arrangement example of the pixels 21 in the pixel region 22 according to a second embodiment. In the second embodiment, the two reference signals REF_A and REF_B are set for the respective pixels 21. Pixels 21_A configured to receive the reference signal REF_A and pixels 21_B configured to receive the reference signal REF_B are adjacent to each other in the row and column directions and arranged in what is generally called a checkerboard pattern.

With this, in a case where the intensity of light is relatively low, it is sufficient to perform AD conversion of pixel signals by use of the reference signal REF_A in the pixels 21_A. In a case where the intensity of light is relatively high, it is sufficient to perform AD conversion of pixel signals by use of the reference signal REF_B in the pixels 21_B.

The other configurations and operations of the second embodiment may be similar to those of the first embodiment. With this, the second embodiment can obtain similar effects to the first embodiment. Further, the second embodiment may be combined with Modified Example 1.

### Third Embodiment

FIG. 10 is a plan view depicting an arrangement example of the pixels 21 in the pixel region 22 according to a third embodiment. In the third embodiment, three reference signals REF_A, REF_B, and REF_C are set for the respective pixels 21. The reference signal REF_C is generated by the slope setting circuit 30 in the first state. However, the slope setting circuit 30 configured to generate the reference signal REF_C has a capacitance ratio of the capacitors C1 and C2 different from that of the slope setting circuit 30 configured to generate the reference signal REF_A.

For example, in the slope setting circuit 30 configured to generate the reference signal REF_A, the capacitors C1 and C2 have almost equal capacitance. In contrast to this, in the slope setting circuit 30 configured to generate the reference signal REF_C, the capacitance of the capacitor C2 is three times greater than the capacitance of the capacitor C1. In this case, the slope of the reference signal REF_A is half of the slope of the reference signal REF_B, and the slope of the reference signal REF_C is one-fourth of the slope of the reference signal REF_B.

With this, AD conversion of pixel signals can be performed with three levels of gain on the basis of the intensity of light. For example, pixels 21_A to 21_C output pixel signals when receiving the reference signals REF_A to REF_C, respectively. In a case where the intensity of light is relatively low, it is sufficient to perform AD conversion of pixel signals by use of the reference signal REF_C in the pixels 21_C. In a case where the intensity of light is medium, it is sufficient to perform AD conversion of pixel signals by use of the reference signal REF_A in the pixels 21_A. In a case where the intensity of light is relatively high, it is sufficient to perform AD conversion of pixel signals by use of the reference signal REF_B in the pixels 21_B.

The pixels 21_A to 21_C may be arranged as depicted in FIG. 10, in which the single pixel 21_A and the single pixel 21_C are arranged for the two pixels 21_B. That is, in a certain pixel row, the pixels 21_A and 21_B are alternately arranged, and in the pixel row adjacent to the one in question, the pixels 21_B and 21_C are alternately arranged. In the plurality of pixel rows adjacent to each other in the row direction, the pixels 21_B are not adjacent to each other and are arranged in a staggered manner. Further, in the plurality of pixel rows adjacent to each other in the row direction, the pixels 21_A and 21_C are not adjacent to each other either and are arranged in a staggered manner.

The other configurations and operations of the third embodiment may be similar to those of the first embodiment. With this, the third embodiment can obtain similar effects to the first embodiment. Further, the third embodiment may be combined with Modified Example 1.

The capacitance ratio of the capacitors C1 and C2 is not necessarily two types and may be set to three or more types. Further, the capacitance ratio of the capacitors C1 and C2 may be different between the pixels. This capacitance ratio is not particularly limited and may be 1:n (n is any positive number).

### Fourth Embodiment

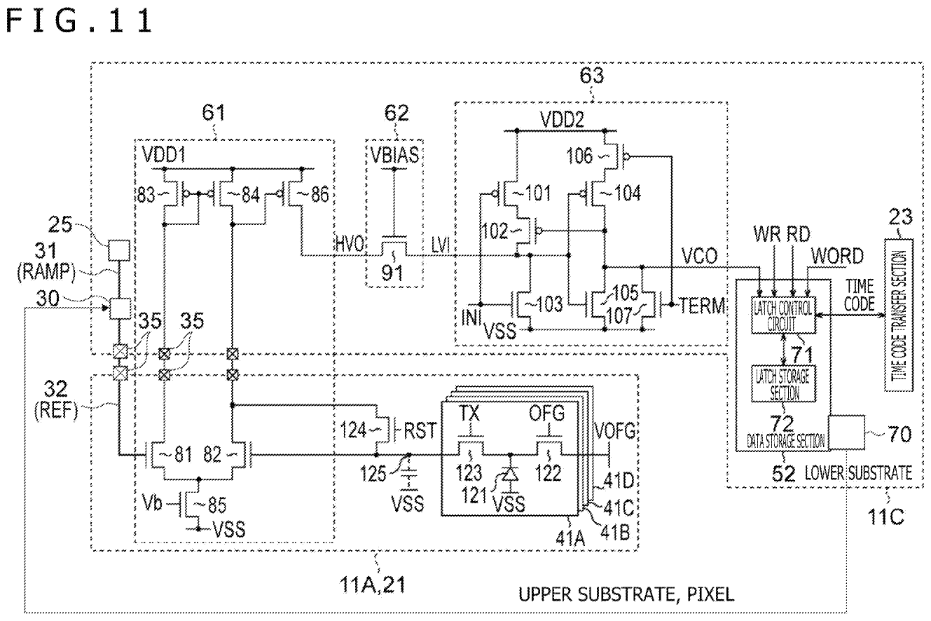

FIG. 11 is a circuit diagram depicting a configuration example of the imaging device 1 according to a fourth embodiment. The fourth embodiment is different from the first embodiment in further including a determination result memory 70. The determination result memory 70 stores the determination result (digital value) obtained by the comparator 61 comparing the reference signal (either REF_A or REF_B) with a pixel signal. The comparison result is output from the determination result memory 70 to the slope setting circuit 30 and used to set the slope of a reference signal in the slope setting circuit 30. The setting circuit 30 sets the rate of change of the reference signal for each pixel on the basis of the determination result of the comparator 61. Further, the comparison result may be output to a signal processing circuit, which is not depicted, along with the reset level and the signal level.

The determination result may be a 1-bit flag indicating whether the voltage level of a pixel signal is higher or lower than a first threshold. For example, in a case where the voltage level of a pixel signal is equal to or higher than the first threshold, it is determined that the intensity of light is relatively low, and the slope setting circuit 30 enters the first state to selectively output the reference signal REF_A. In a case where the voltage level of a pixel signal is lower than the first threshold, it is determined that the intensity of light is relatively high, and the slope setting circuit 30 enters the second state to selectively output the reference signal REF_B. That is, in the fourth embodiment, the pixel 21 that receives the reference signal REF_A and the pixel 21 that receives the reference signal REF_B are not fixed. On the basis of the intensity of light, the reference signal REF_A or REF_B is output to all the pixels 21. With this, the pixel signals from all the pixels 21 in the pixel region 22 can be efficiently AD-converted and utilized. As a result, this leads to the improvement of image quality.

In a case where the determination result is a 1-bit flag, the determination result memory 70 may be a 1-bit memory.

In the fourth embodiment, the comparator 61 compares the reference signal RAMP (REF_B) with a pixel signal to determine whether the voltage level of the pixel signal is higher or lower than the first threshold. Thus, after the detection of the reset level of a pixel signal and before the detection of the signal level, the comparator 61 performs the determination processing of comparing the signal level with the first threshold.

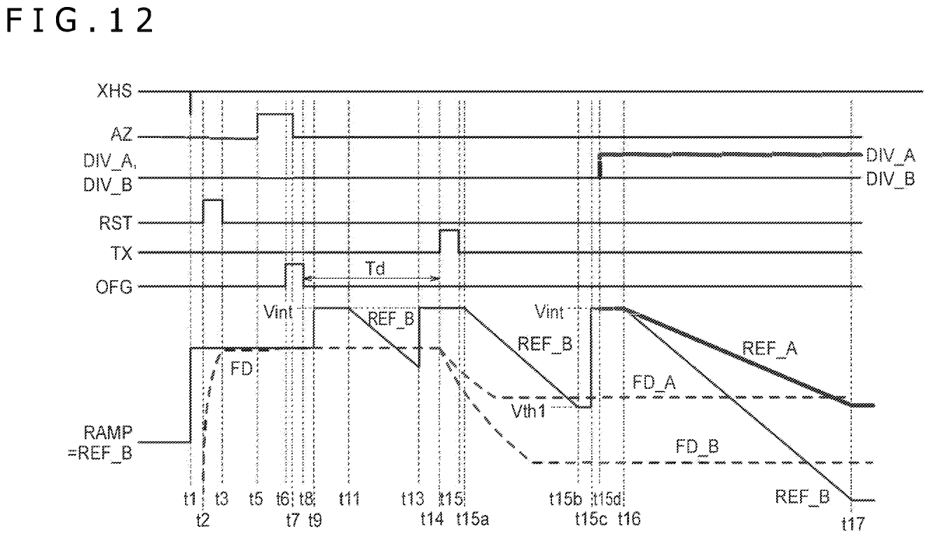

FIG. 12 is a timing chart depicting an example of the operation of the imaging device 1 according to the fourth embodiment. The determination processing is executed in the period from t15a to t15d. Further, in the fourth embodiment, except for the operation of the control signal DIV A, the operation in the period from t1 to t15 is basically the same as the operation in the period from t1 to t15 of the first embodiment. The control signal DIV A is maintained at a low level until t15d, similar to the control signal DIV_B, and rises to a high level at and after t15d, which comes just before the detection operation of the signal level. Thus, the slope setting circuit 30 corresponding to any of the pixels 21 outputs the reference signal RAMP (=REF_B) until t15d. At and after t15d, which comes just before the detection operation of the signal level, the reference signals REF_A and REF_B are selectively output.

The determination processing (t15a to t15b) is executed after the detection of the reset level of a pixel signal (t11 to t13) and before the detection of the signal level (t16 to t17). Now, the determination processing (t15a to t15d) is described.

After the detection of the reset level, at t13, the reference signal RAMP is set again to the initial voltage Vint at the start of the slope operation.

Next, at t14, the control signal (transfer signal) TX rises, and the transistor 123 transfers the charges (for example, electrons) accumulated in the PD 121 to the FD 125. With this, the potential of the FD 125 varies depending on the intensity of light received by the PD 121. For example, in the case of low light intensity, as the pixel signal FD_A, the potential of the FD 125 does not drop significantly. On the other hand, in the case of high light intensity, as the pixel signal FD_B, the potential of the FD 125 drops significantly.

Next, at t15, the control signal TX falls, and the transistor 123 is turned off.

Next, at t15a, the slope operation of the reference signal RAMP starts. At this time, the control signals DIV A and DIV_B are both maintained at a low level and change with the slope of the reference signal RAMP (REF_B) in all the pixels 21 to be detected.

When the reference signal REF_B drops to a first threshold Vth1 at t15b, at t15c, the reference signal REF_B returns to the initial voltage Vint. When the reference signal REF_B drops to the first threshold Vth1, it can be determined whether the signal level is higher or lower than the first threshold Vth1 in each of the pixels 21. For example, in a case where the intensity of light is relatively low and the pixel signal is FD_A, in the determination period from t15a to t15b, the reference signal REF_B crosses the pixel signal FD_A, and hence, the logic of the output signal HVO of the comparator 61 is inverted. On the other hand, for example, in a case where the intensity of light is relatively high and the pixel signal is FD_B, the reference signal REF_B does not cross the pixel signal FD_B in the determination period from t15a to t15b, and hence, the logic of the output signal HVO of the comparator 61 is not inverted. With this, it can be determined whether the signal level of each pixel is higher or lower than the reference signal RAMP (REF_B).

This determination result is stored in the determination result memory 70 and output to the slope setting circuit 30. The slope setting circuit 30 receives either the control signal DIV A or DIV_B as a determination result and enters the first state or the second state. For example, in a case where the slope setting circuit 30 receives the control signal DIV A (high level) as a determination result, the slope setting circuit 30 enters the first state and outputs the reference signal REF_A. In a case where the slope setting circuit 30 receives the control signal DIV_B (low level) as a determination result, the slope setting circuit 30 enters the second state and outputs the reference signal REF_B.

With this, at and after t16, in a case where the signal level is higher than the first threshold Vth1 (the intensity of light is low) and the signal level is FD_A, the slope setting circuit 30 outputs the reference signal REF_A to allow the imaging device 1 to obtain high image quality pixel signals with high gain by use of the reference signal REF_A. On the other hand, in a case where the signal level is lower than the first threshold Vth1 (the intensity of light is high) and the signal level is FD_A, the slope setting circuit 30 outputs the reference signal REF_B to allow the imaging device 1 to quickly detect pixel signals in a short period of time by use of the reference signal REF_B, although the gain is low.

The other operations of the fourth embodiment may be similar to those of the first embodiment. Thus, the fourth embodiment can also obtain similar effects to the first embodiment. The fourth embodiment may be combined with Modified Example 1 or the second or third embodiment.

### Modified Example 2

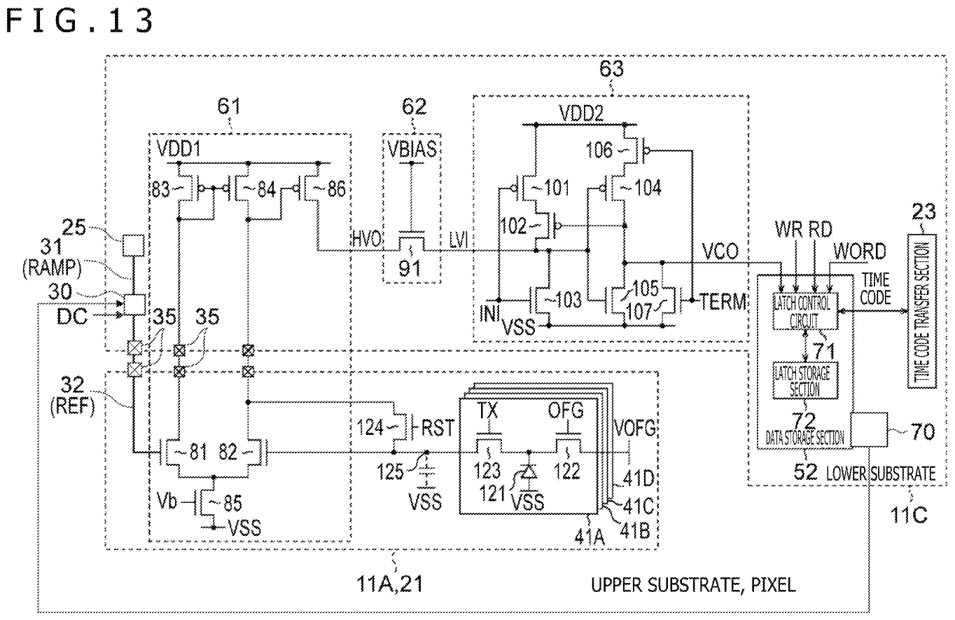

FIG. 13 is a circuit diagram depicting a configuration example of the imaging device 1 according to Modified Example 2 of the fourth embodiment. According to Modified Example 2, the DC (Direct Current) value used in the determination processing is input to the slope setting circuit 30. The other configurations of Modified Example 2 may be the same as those of the fourth embodiment.

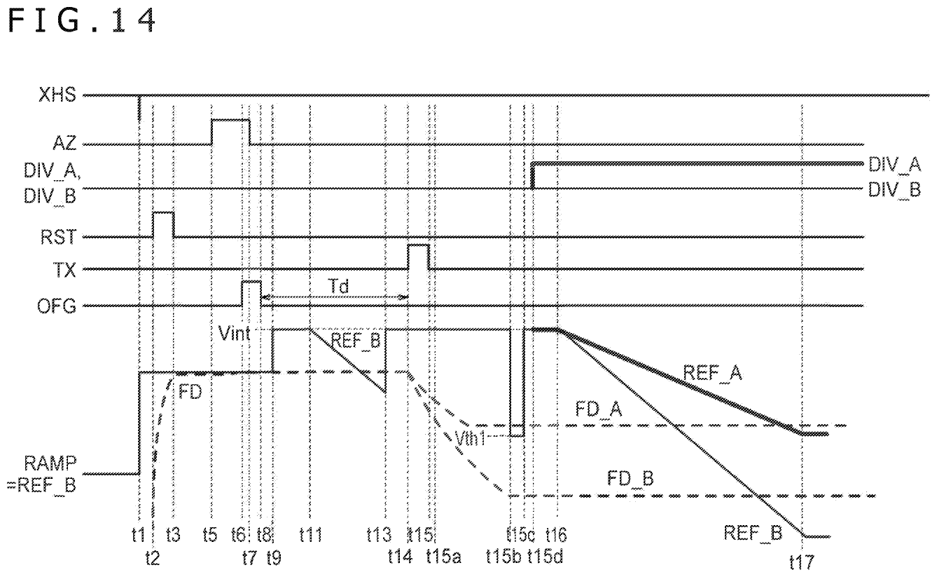

FIG. 14 is a timing chart depicting an example of the operation of the imaging device 1 according to Modified Example 2. The imaging device 1 according to Modified Example 2 determines, in the determination processing (t15a to t15d), whether the signal level is higher or lower than the first threshold Vth1 by using a DC signal, without using the reference signal REF_B.

For example, the DC value is set to the voltage level of the first threshold Vth1 and input to the slope setting circuit 30. The slope setting circuit 30 outputs this DC value to the comparator 61 in the determination period from t15c to t15d. With this, Modified Example 2 can determine whether the signal level of each pixel is higher or lower than the first threshold Vth1.

In Modified Example 2, the DC value serving as a reference signal in the determination processing has a slope that is almost vertical and drops to the first threshold Vth1 in a short period of time (almost immediately) at t15b. That is, the slope of the DC value serving as a reference signal in the determination processing is greater than the slopes of the reference signals REF_A and REF_B (RAMP) in the detection processing of the reset level and the signal level. Thus, the period of the determination processing is shortened. With this, the time required for AD conversion can further be shortened.

The other configurations and operations of Modified Example 2 may be similar to those of the fourth embodiment. Thus, Modified Example 2 can obtain the effects of the fourth embodiment. Further, Modified Example 2 may be combined with the first to third embodiments or Modified Example 1.

### Fifth Embodiment

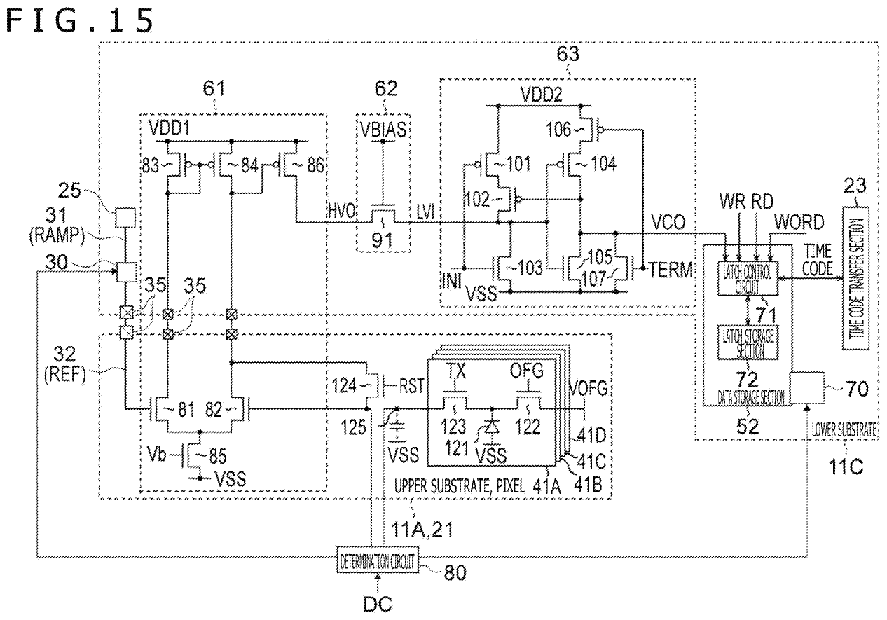

FIG. 15 is a circuit diagram depicting a configuration example of the imaging device 1 according to a fifth embodiment. According to the fifth embodiment, the imaging device 1 further includes a determination circuit 80. The determination circuit 80 is connected between the FD 125 and the gate (first input section) of the transistor 82 and determines whether the voltage level of an analog pixel signal is higher or lower than a second threshold. The slope setting circuit 30 sets the slope of the reference signal RAMP for each pixel on the basis of the determination result of the determination circuit 80. The determination circuit 80 may be a differential circuit configured to receive a DC value having the voltage level of the second threshold as input and compare this DC value with the voltage level of an analog pixel signal. In this manner, it may be determined whether the intensity of light is high or low by use of analog pixel signals.

The determination result memory 70 stores the determination result obtained by the comparator 61 comparing the reference signal (either REF_A or REF_B) with a pixel signal. The comparison result is output from the determination circuit 80 or the determination result memory 70 to the slope setting circuit 30 and used to set the slope of a reference signal in the slope setting circuit 30. The setting circuit 30 sets the rate of change of a reference signal for each pixel on the basis of the determination result of the comparator 61. Further, the comparison result may be output to a signal processing circuit, which is not depicted, along with the reset level and the signal level.

The other configurations of the fifth embodiment may be similar to those of the fourth embodiment. Further, the operation of the fifth embodiment may be the same as that of Modified Example 2 described above. With this, the fifth embodiment can obtain similar effects to Modified Example 2 of the fourth embodiment. The fifth embodiment may be combined with any of the first to third embodiments and Modified Example 1.

Note that, in the above-mentioned embodiments and Modified Examples, the slope setting circuit 30 is provided on a different substrate from the pixel circuit 41 and the comparator 61 and electrically connected to the pixel circuit 41 and the comparator 61 by wire bonding (Cu—Cu bonding). However, the slope setting circuit 30 may be provided on the same substrate as the pixel circuit 41 and the comparator 61. In this case, the slope setting circuit 30 is electrically connected to the pixel circuit 41 and the comparator 61 by normal wiring without using wire bonding such as Cu—Cu bonding.

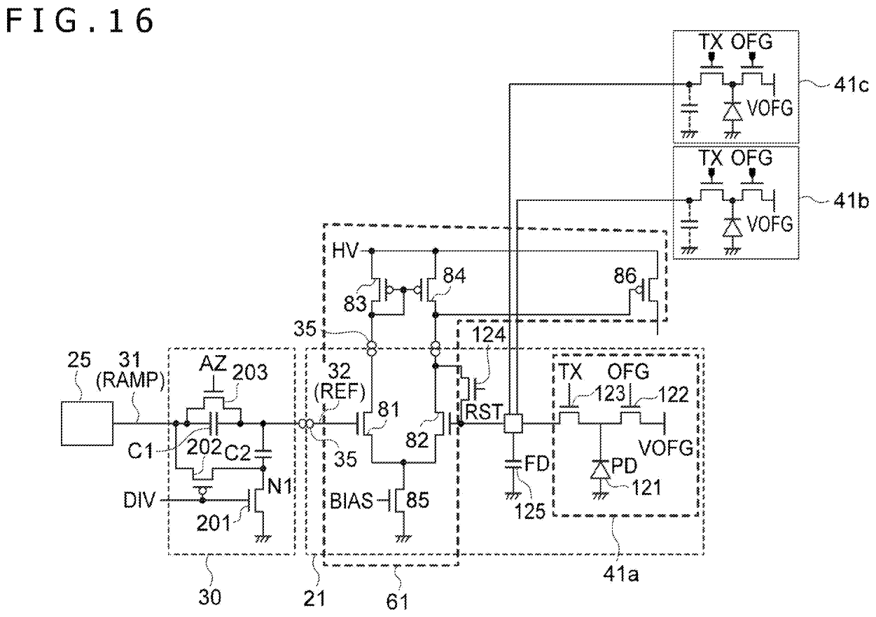

Further, in the above-mentioned embodiments and Modified Examples, the peripheral circuits such as the comparator 61 and the slope setting circuit 30 may be shared by the plurality of pixel circuits 41. For example, FIG. 16 is a diagram depicting a configuration example of the imaging device 1 in which a plurality of pixel circuits 41a to 41c shares the peripheral circuits such as the comparator 61 and the slope setting circuit 30. In the example of FIG. 16, the three pixel circuits 41a to 41c share the peripheral circuits such as the comparator 61 and the slope setting circuit 30. The other configurations of the imaging device 1 of this example may be the same as those of any of the first to fifth embodiments, Modified Example 1, and Modified Example 2. With this, the imaging device 1 can be miniaturized. The number of pixel circuits that share the peripheral circuits such as the comparator 61 and the slope setting circuit 30 is not particularly limited and may be two or four or more.

In the above-mentioned embodiments, the imaging device 1 includes the two semiconductor substrates 11, but the imaging device 1 may include the three semiconductor substrates 11.

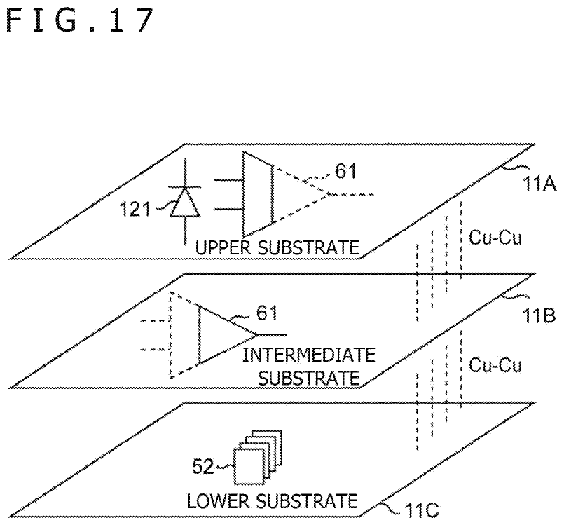

For example, FIG. 17 is a conceptual diagram of the imaging device 1 configured by stacking the three semiconductor substrates 11, namely, an upper substrate 11A, an intermediate substrate 11B, and a lower substrate 11C.

On the upper substrate 11A, the pixel circuit 41 including the photodiode 121, and at least some circuits of the comparator 61 are formed. On the lower substrate 11C, the data storage section 52 configured to store time codes, and the time code transfer section 23 are at least formed. On the Intermediate substrate 11B, the remaining circuits of the comparator 61, which are not arranged on the upper substrate 11A, are formed. The bonding between the upper substrate 11A and the intermediate substrate 11B, and the bonding between the intermediate substrate 11B and the lower substrate 11C are achieved by metal bonding such as Cu—Cu bonding. The slope setting circuit 30, the DAC 25, and the determination circuit 80 may be provided on either the intermediate substrate 11B or the lower substrate 11C.

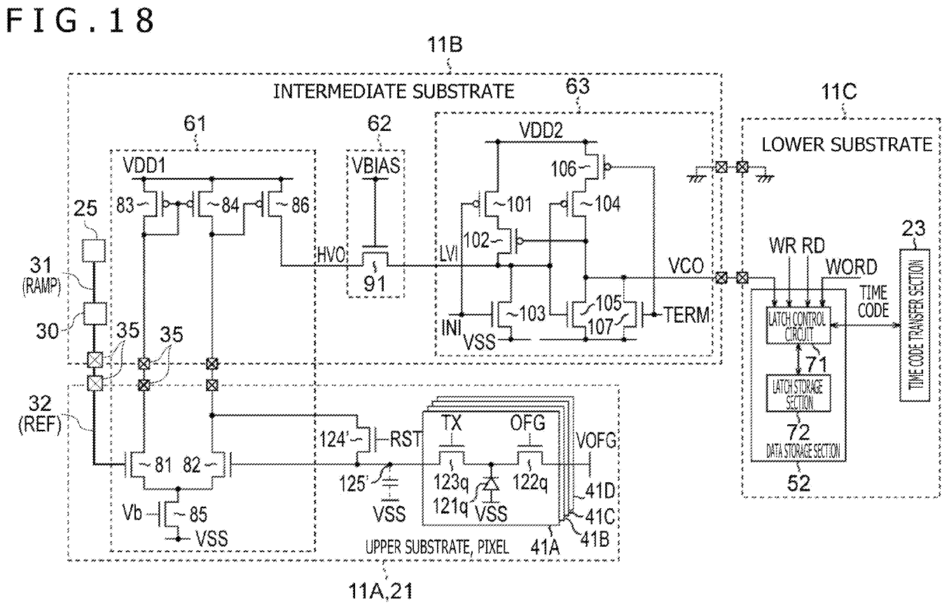

FIG. 18 depicts circuit arrangement examples of the respective semiconductor substrates 11 in a case where the imaging device 1 is formed with the three semiconductor substrates 11.

In the example of FIG. 18, the circuits arranged on the upper substrate 11A are the same as the circuits on the upper substrate 11A of FIG. 4, and the remaining circuits of the comparator 61 are arranged on the intermediate substrate 11B, while the data storage section 52 and the time code transfer section 23 are arranged on the lower substrate 11C.

In the example depicted in FIG. 18, the slope setting circuit 30, the DAC 25, the determination circuit 80, and the like may be provided on either the intermediate substrate 11B or the lower substrate 11C. Further, another substrate may also be stacked on the lower substrate 11C, and the slope setting circuit 30, the DAC 25, the determination circuit 80, and the like may be formed on the substrate in question.

Further, a configuration in which the imaging device 1 has a stacked structure and the ADCs 42 are connected to the respective pixels can also be employed. For example, a configuration in which photoelectric conversion elements (photodiodes 121) are included in the first layer, conversion sections (ADC 42) are connected to the respective photoelectric conversion elements, and the conversion sections are formed in the second layer beneath the first layer can also be employed.

Further, a structure including two or more layers of a plurality of image sensors (imaging devices 1) can also be employed, and the plurality of image sensors can serve as the imaging devices 1 configured to detect respective different types of light, such as radiation, infrared light, and ambient light, for example.

### <Application Example to Mobile Body>

The technology according to the present disclosure (present technology) can be applied to various products. For example, the technology according to the present disclosure may be implemented as a device that is mounted on a mobile body of any type, such as automobiles, electric vehicles, hybrid electric vehicles, motorcycles, bicycles, personal mobilities, airplanes, drones, ships, and robots.

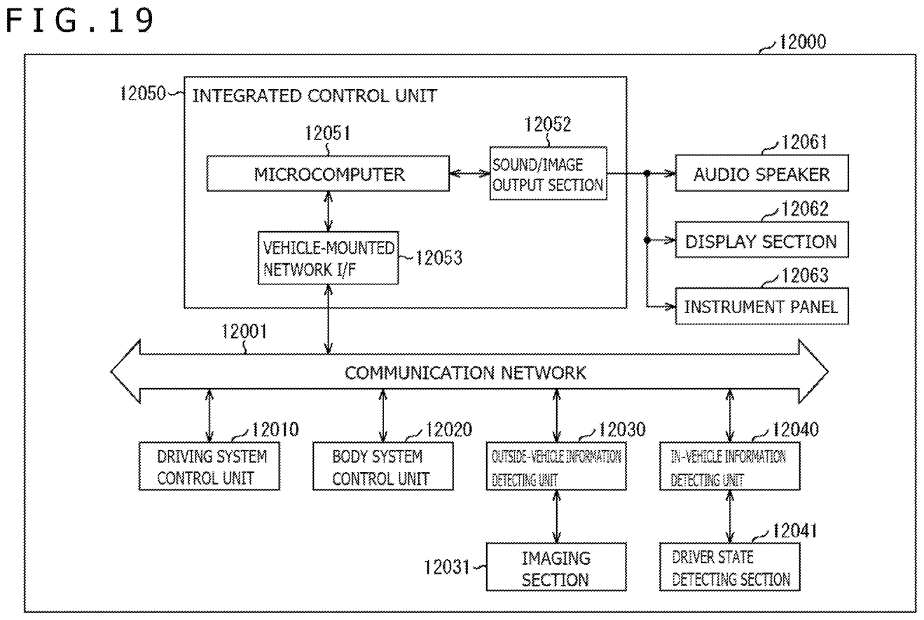

FIG. 19 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 19, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 19, an audio speaker 12061, a display section 12062, and an instrument panel 12063 are illustrated as the output device. The display section 12062 may, for example, include at least one of an on-board display and a head-up display.

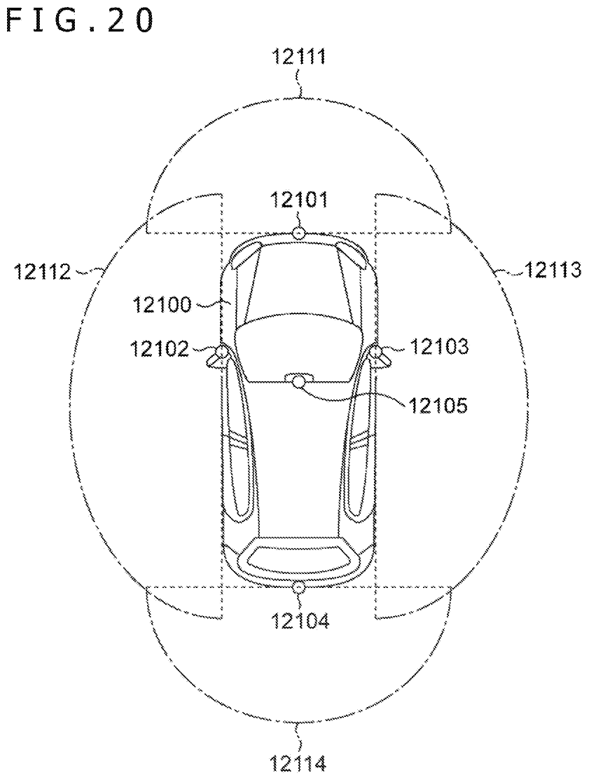

FIG. 20 is a diagram depicting an example of the installation position of the imaging section 12031.

In FIG. 20, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 20 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031, among the configurations described above, for example.

Note that the present technology can take the following configuration.

(1)

An imaging device including:
a plurality of pixels configured to perform photoelectrical conversion;
a plurality of comparators each including a first input section configured to receive a pixel signal from a corresponding one of the pixels and a second input section configured to receive a reference signal to be compared with the pixel signal, the comparators being provided in correspondence with the plurality of respective pixels;
a reference signal line configured to transmit the reference signal; and
a setting circuit provided between the reference signal line and the second input section and configured to set a rate of change of a voltage level of the reference signal over time.
   (2)

The imaging device according to (1),
in which the setting circuit includes
   a first capacitive element provided between the reference signal line and the second input section,
   a second capacitive element provided between the second input section and a ground voltage source,
   a first transistor of a first conductivity type provided between the second capacitive element and the ground voltage source, and
   a second transistor of a second conductivity type provided between a node between the second capacitive element and the first transistor, and the reference signal line, the second transistor having a gate connected to a gate of the first transistor in common.
      (3)

The imaging device according to (2),
in which, in a first state where the first transistor is in a conducting state and the second transistor is in a non-conducting state, the first capacitive element and the second capacitive element change the voltage level of the reference signal at a first rate of change, and,
in a second state where the first transistor is in a non-conducting state and the second transistor is in a conducting state, the first capacitive element and the second capacitive element change the reference signal at a second rate of change.
   (4)

The imaging device according to (3),
in which the setting circuit further includes a third transistor connected in parallel to the first capacitive element,
when all the pixels to be detected are in the second state, the setting circuit temporarily sets the third transistor to a conducting state to equalize a voltage level between the reference signal line and the second input section, and,
after a transition of the voltage level of the reference signal to a change start level, each of the pixels enters either the first state or the second state.
   (5)

The imaging device according to (3),
in which the setting circuit further includes a third transistor connected in parallel to the first capacitive element,
when all the pixels to be detected are in the second state, the setting circuit temporarily sets the third transistor to a conducting state to equalize a voltage level between the reference signal line and the second input section, and,
before a transition of the voltage level of the reference signal in the first state or the second state to a change start level, each of the pixels enters either the first state or the second state.
   (6)

The imaging device according to (3),
in which the setting circuit changes the reference signal at the first rate of change in a first pixel of the plurality of pixels and changes the reference signal at the second rate of change in a second pixel of the plurality of pixels.
   (7)

The imaging device according to any one of (1) to (6),
in which a capacitance ratio of the first capacitive element and the second capacitive element is different between the pixels.
   (8)

The imaging device according to (7),
in which the setting circuit changes the reference signal at the first rate of change in a first pixel of the plurality of pixels, changes the reference signal at the second rate of change in a second pixel of the plurality of pixels, and changes the reference signal at a third rate of change, which is different from the first rate of change and the second rate of change, in a third pixel of the plurality of pixels.
   (9)

The imaging device according to any one of (1) to (8),
in which the comparators each execute determination processing of comparing the reference signal with the pixel signal to determine whether a voltage level of the pixel signal is higher or lower than a first threshold, and the setting circuit sets the rate of change of the reference signal for each of the pixels on the basis of a determination result of the determination processing.
   (10)

The imaging device according to (9),
in which, in the determination processing, the rate of change of the reference signal is greater than the rate of change of the reference signal in detection processing of the pixel signal.
   (11)

The imaging device according to any one of (1) to (8), further including:
a determination circuit configured to determine whether a voltage level of the pixel signal is higher or lower than a second threshold,
in which the setting circuit sets the rate of change of the reference signal for each of the pixels on the basis of a determination result of the determination circuit.
   (12)

The imaging device according to any one of (9) to (11), further including:
a determination result memory configured to retain the determination result.
   (13)

The imaging device according to any one of (1) to (12),
in which the setting circuit is formed on the same substrate as the plurality of pixels.
   (14)

The imaging device according to any one of (1) to (12), including:
a first substrate having provided thereon the plurality of pixels; and
a second substrate having provided thereon the setting circuit and stacked on the first substrate.
   (15)

An imaging device including:
a plurality of pixels configured to perform photoelectric conversion;
a comparator including a first input section configured to receive a pixel signal from a corresponding one of the pixels and a second input section configured to receive a reference signal to be compared with the pixel signal;
a reference signal line configured to transmit the reference signal to the second input section; and
a setting circuit provided between the reference signal line and the second input section and configured to set a rate of change of a voltage level of the reference signal over time,
in which the comparator and the setting circuit are shared by the plurality of pixels.

The present disclosure is not to be limited to the embodiments described above and may be modified in various ways within a scope not deviating from the gist thereof. Further, the effects described in the present specification are merely illustrative and not restrictive, and other effects may also be achieved.

### REFERENCE SIGNS LIST

1: Imaging device
11: Semiconductor substrate
21: Pixel
22: Pixel region
25: DAC
30: Slope setting circuit
41: Pixel circuit
61: Differential input circuit (comparator)
121: PD
122: Discharge transistor
123: Transfer transistor
124: Reset transistor
125: FD
81 to 86: Transistor
70: Determination result memory
80: Determination circuit

1. An imaging device comprising:
a plurality of pixels configured to perform photoelectrical conversion;
a plurality of comparators each including a first input section configured to receive a pixel signal from a corresponding one of the pixels and a second input section configured to receive a reference signal to be compared with the pixel signal, the comparators being provided in correspondence with the plurality of respective pixels;
a reference signal line configured to transmit the reference signal; and
a setting circuit provided between the reference signal line and the second input section and configured to set a rate of change of a voltage level of the reference signal over time.

2. The imaging device according to claim 1,
wherein the setting circuit includes
a first capacitive element provided between the reference signal line and the second input section,
a second capacitive element provided between the second input section and a ground voltage source,
a first transistor of a first conductivity type provided between the second capacitive element and the ground voltage source, and
a second transistor of a second conductivity type provided between a node between the second capacitive element and the first transistor, and the reference signal line, the second transistor having a gate connected to a gate of the first transistor in common.

3. The imaging device according to claim 2,
wherein, in a first state where the first transistor is in a conducting state and the second transistor is in a non-conducting state, the first capacitive element and the second capacitive element change the voltage level of the reference signal at a first rate of change, and,
in a second state where the first transistor is in a non-conducting state and the second transistor is in a conducting state, the first capacitive element and the second capacitive element change the reference signal at a second rate of change.

4. The imaging device according to claim 3,
wherein the setting circuit further includes a third transistor connected in parallel to the first capacitive element,
when all the pixels to be detected are in the second state, the setting circuit temporarily sets the third transistor to a conducting state to equalize a voltage level between the reference signal line and the second input section, and,
after a transition of the voltage level of the reference signal to a change start level, each of the pixels enters either the first state or the second state.

5. The imaging device according to claim 3,
wherein the setting circuit further includes a third transistor connected in parallel to the first capacitive element,
when all the pixels to be detected are in the second state, the setting circuit temporarily sets the third transistor to a conducting state to equalize a voltage level between the reference signal line and the second input section, and,
before a transition of the voltage level of the reference signal in the first state or the second state to a change start level, each of the pixels enters either the first state or the second state.

6. The imaging device according to claim 3,
wherein the setting circuit changes the reference signal at the first rate of change in a first pixel of the plurality of pixels and changes the reference signal at the second rate of change in a second pixel of the plurality of pixels.

7. The imaging device according to claim 2,
wherein a capacitance ratio of the first capacitive element and the second capacitive element is different between the pixels.

8. The imaging device according to claim 7,
wherein the setting circuit changes the reference signal at the first rate of change in a first pixel of the plurality of pixels, changes the reference signal at the second rate of change in a second pixel of the plurality of pixels, and changes the reference signal at a third rate of change, which is different from the first rate of change and the second rate of change, in a third pixel of the plurality of pixels.

9. The imaging device according to claim 1,
wherein the comparators each execute determination processing of comparing the reference signal with the pixel signal to determine whether a voltage level of the pixel signal is higher or lower than a first threshold, and
the setting circuit sets the rate of change of the reference signal for each of the pixels on a basis of a determination result of the determination processing.

10. The imaging device according to claim 9,
wherein, in the determination processing, the rate of change of the reference signal is greater than the rate of change of the reference signal in detection processing of the pixel signal.

11. The imaging device according to claim 1, further comprising:
a determination circuit configured to determine whether a voltage level of the pixel signal is higher or lower than a second threshold,
wherein the setting circuit sets the rate of change of the reference signal for each of the pixels on a basis of a determination result of the determination circuit.

12. The imaging device according to claim 9, further comprising:
a determination result memory configured to retain the determination result.

13. The imaging device according to claim 1,
wherein the setting circuit is formed on a same substrate as the plurality of pixels.

14. The imaging device according to claim 1, comprising:
a first substrate having provided thereon the plurality of pixels; and
a second substrate having provided thereon the setting circuit and stacked on the first substrate.

15. An imaging device comprising:
a plurality of pixels configured to perform photoelectric conversion;
a comparator including a first input section configured to receive a pixel signal from a corresponding one of the pixels and a second input section configured to receive a reference signal to be compared with the pixel signal;
a reference signal line configured to transmit the reference signal to the second input section; and
a setting circuit provided between the reference signal line and the second input section and configured to set a rate of change of a voltage level of the reference signal over time,
wherein the comparator and the setting circuit are shared by the plurality of pixels.
